(19) United States
(12) Patent Application Publication
(10) Pub. No.: US 2019/0114705 A1
(43) Pub. Date: Apr. 18, 2019

(54) SYSTEMS AND METHODS FOR OPTIMIZING COMPUTER RESOURCES FOR MULTIPLE AUTOMOBILE TRANSACTIONS

(71) Applicant: Nowcom Corporation, Los Angeles, CA (US)

(72) Inventors: Wayne Wong, Rosemead, CA (US); Glen Suares, Los Angeles, CA (US); Ricky Li, Rosemead, CA (US); Vimal Nair, Cypress, CA (US)

(21) Appl. No.: 16/152,563

(22) Filed: Oct. 5, 2018

Related U.S. Application Data
(60) Provisional application No. 62/573,952, filed on Oct. 18, 2017.

(51) Int. Cl. G06Q 40/02; G06Q 10/06; G06Q 10/08

(52) U.S. Cl. CPC G06Q 40/025; G06Q 10/087; G06Q 10/06393

(57) ABSTRACT

A method and system for optimizing use of computer resources in performing multiple automobile transactions for multiple customers which initially preloads a plurality of storage units with inventory data and lender constraints. Input in the form of a customer request is received from at least one customer. The method computes an operational metric whether to adjust the number of storage units to an optimized number of storage units including at least one available storage unit. The method sends a command to adjust the number of storage units to the optimized number of storage units based on the computing step. Each storage unit added is automatically loaded with the inventory data and lender constraints. The input is assigned to the at least one available storage unit and an output for the customer is immediately or near instantaneously computed based on the input, inventory data and lender constraints and despite the inventory data including automobile data from multiple automobiles across a wide range of dealer lots, and despite the lender constraints including lender constraints from multiple lenders. The type of computer resources to be adjusted may vary and in embodiments include preloaded containers created on virtual machines, which are run on one or more servers.

### CROSS-REFERENCE TO RELATED APPLICATIONS

This application claims the priority to provisional patent application No. 62/573,952, filed Oct. 18, 2017, entitled “SYSTEMS AND METHODS FOR OPTIMIZING COMPUTER RESOURCES FOR MULTIPLE AUTOMOBILE TRANSACTIONS.”

### BACKGROUND OF THE INVENTION

The present invention relates to automated credit approval systems and methods. More specifically, the present invention relates to automated credit approval systems and methods used when conducting a financial transaction for a vehicle.

In the used car industry, there are many people with sub-prime credit who are looking to purchase a vehicle. In general, people with bad credit are simply looking to buy any reasonably drive-worthy vehicle that the dealer is willing to sell to them and for which they are able to obtain financing provided the financing company agrees to the down payment amount and the monthly payment amount they can afford. Historically, in order for a person with bad credit to receive approval on financing, a lender would need to review the person's loan application and make a determination as to whether financing would be approved or rejected. In many instances, this process could be three or four days, thus preventing a deal from being made on the spot. Anytime, the person leaves the car lot without the deal being completed there is a greater chance that the person will walk away without purchasing the vehicle.

Referring to FIG. 1 a flow diagram 100 is shown depicting an example of a sub-prime automobile financing procedure according to the prior art.

First, in step 102, a customer goes to a dealership to review car inventory in the hopes of finding a vehicle to purchase. If the customer cannot pay for the vehicle with available cash, the customer will most likely look to finance the vehicle. A sub-prime customer (i.e. a customer with a credit score that is less than ideal) brings the initial down payment to the deal and also usually has a requested maximum monthly payment. The customer is generally less concerned (if at all) with other terms of the deal, such as, for example, the vehicle cost, the vehicle type, loan term and the interest rate of the loan. These other terms of the deal are less important because the customer generally is simply looking to purchase any vehicle he/she qualifies for.

Next, in step 104, the customer will ask to see what vehicles he/she qualifies for based on the down payment and the monthly payment the customer can afford. In step 106, the dealer utilizes a software program, such as the Deal Management Software System, disclosed and described in U.S. patent application Ser. No. 10/043,676, filed Jan. 9, 2002, entitled METHODS AND SYSTEMS FOR DEAL STRUCTURING FOR AUTOMOBILE DEALERS, to input or adjust the price, financing loan-term length, interest rate, trade-in value of the customer's vehicle, and other input parameters to try meet the customer's needs.

Another such program is described in U.S. patent application Ser. No. 11/332,616, filed Jan. 13, 2006, entitled METHODS AND SYSTEMS FOR DEAL STRUCTURING FOR AUTOMOBILE DEALERS which application is incorporated herein by reference in its entirety.

Based on the values input by the dealer, the software program calculates the customer's monthly payment, down payment, the dealer's gross profit from the sale, and other information, as shown in step 108. Following, in step 110, the dealer compares the resulting monthly and down payments and other factors with those requested by the customer. If the monthly and down payments and other factors are comparable to those requested by the customer, the dealer moves on to step 112. Otherwise, the dealer must go back to step 106 and adjust the price, term, interest rate, and other variables of the deal. At step 112, the dealer checks to see whether he will sufficiently profit from the deal. For instance, if the dealer has a minimum desired gross profit of $1000 per car, and the profit from the deal results in only an $800 profit, the dealer will adjust the price, term, interest rate, and other variables of the deal at step 106.

Once the dealer's profit meets a sufficient level and the customer's down payment value and monthly payment value have been approximately met, at step 114, the dealer presents the deal to the customer, who can either reject the deal, sending the process back to step 106, or accept the deal, as shown in step 116. Presumably, the customer will accept the deal, since the customer's requests regarding the monthly payment and the down payment have been met. As is apparent, this prior art procedure requires the dealer to manually adjust terms of the deal to try to meet both the dealer's and the customer's financial needs. Additionally, this can result in financing deals that do not provide the dealer with the greatest profit as there is no way for the dealer to know what deal structure will provide him/her the greatest profit, waste the dealer and customer's time, potentially leave the customer buying a car that does not best meet his/her needs and potentially lose business by not making a deal at all.

Various automated loan approval systems are described in the literature including Patent Publication No. 20160042450, filed Jun. 9, 2015, entitled METHODS AND SYSTEMS FOR DEAL STRUCTURING FOR AUTOMOBILE DEALERS; U.S. Pat. No. 6,950,807, issued Sep. 27, 2005, entitled SYSTEM AND METHOD FOR PROVIDING FINANCING; and U.S. Pat. No. 8,560,438, issued Oct. 15, 2013, entitled SYSTEMS AND METHODS FOR OPTIMIZATION OFA FINANCIAL TRANSACTION, each of which is incorporated herein by reference in its entirety.

Over time, the speed to determine the terms of a loan for a customer for one vehicle has improved. “Desking” the customer, for example, is a term of trade referring to when checking a customer's ability to purchase a vehicle, the dealership will take the customer's credit history data and run it against a single vehicle to determine the risk score of the customer and the vehicle combined, which will affect the terms of the loan (down payment needed, APR, length of loan, etc.). “Desking” the customer has been reduced from days to seconds. However, every time a new deal is created, or another deal modified, the “decking” calculation takes around 1 second to complete the new terms.

Although the above described systems have reduced the time to determine terms for a new deal for one customer for a single car on a single lot and for a single lender, a number of shortcomings still exist not the least of which is to determine loan terms for additional cars, additional dealers, and additional customers and in real time or in parallel.

Additionally, scaling up computations using multiple servers is challenging because each server or server group has a limited bandwidth for concurrent requests. If each server can only handle X number of concurrent requests at once, a new technique to scale resources is required for handling more requests at once. The above described procedures do not address this challenge.

Additionally, keeping the data synced across all the different servers is another challenge. Failure to do so risks inaccurate data, and erroneous terms of the loan. Changes are desirable across all servers in near instantaneous time.

These and other shortcomings are addressed by the present invention described herein.

### SUMMARY OF THE INVENTION

A system and related methods optimize use of computer resources in performing multiple automobile transactions for one or more customers.

In embodiments, a method for optimizing use of computer resources in performing multiple automobile transactions for multiple customers initially preloads a plurality of storage units with inventory data and lender constraints. Input in the form of a customer request is received from at least one customer. The method computes an operational metric whether to adjust the number of storage units to an optimized number of storage units including at least one available storage unit. The method sends a command to adjust the number of storage units to the optimized number of storage units based on the computing step. Each storage unit added is automatically loaded with the inventory data and lender constraints. The input is assigned to the at least one available storage unit and an output for the customer is instantaneously or near instantaneously computed based on the input, inventory data and lender constraints and despite the inventory data including automobile data from multiple automobiles across a wide range of dealer lots, and despite the lender constraints including lender constraints from multiple lenders.

The type of computer resources to be adjusted may vary and in embodiments include preloaded containers created on virtual machines, which are run on one or more servers.

In embodiments, a system computes in real time a customer's monthly payment and other outputs for multiple vehicles all at once based on the customers personal information. The system improves the computing speed and efficiency by loading all the vehicle data to the local server(s) level, and passes only the customer data between the servers. Passing only the customer data significantly reduces the amount of data to be transferred, computing power, memory, and time to carry out the computations.

In embodiments, a system includes a processor that determines whether to increase the number of servers available for the customer requests instantly and in real time based on the application load. Utilizing the present invention, a practically unlimited amount of computer resources (e.g., servers, virtual machines, and containers) is obtained. In embodiments, a server farm is provided that acts as an on-premises cloud computing farm, with computer resources being created instantly as needed and with access to all of the existing inventory, dealer and lender data.

In embodiments, a system employs limited small data transfer jobs to ensure that all the vehicle data is available across all local servers constantly. In particular embodiments, each storage unit or container includes a container processor operable to communicate with various inventory databases and to run periodically (or in the background) a program updating its vehicle inventory data, dealer data, and lender templates.

In embodiments, a system includes a central processor operable to receive the customer data requests, and automatically distribute the request load against all available computer resources (e.g., servers, VMs, and containers) to keep each server working at maximum capacity and efficiency. In some embodiments the central processor assigns the request to a newly added storage unit such as a newly added container.

The following is a non-exhaustive listing of optional non-required objects of the present invention: (a) to show a customer her monthly payment for every vehicle on a dealer lot; (b) to run the customer's data against each and every vehicle on the dealer's lot; (c) to run the customer's data not only against vehicles on a dealer's lot, which would usually not be more than a couple hundred, but to a large online database of hundreds of thousands of vehicles all at once (e.g., all in the same time frame of the previous calculation described above which was based on only one customer and only one vehicle); and (d) to simultaneously compute the above described calculations for multiple customers (e.g., thousands or more).

Still other descriptions, objects and advantages of the present invention will become apparent from the detailed description to follow, together with the accompanying drawings.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a flow diagram depicting a sub-prime automobile financing procedure according to the prior art;

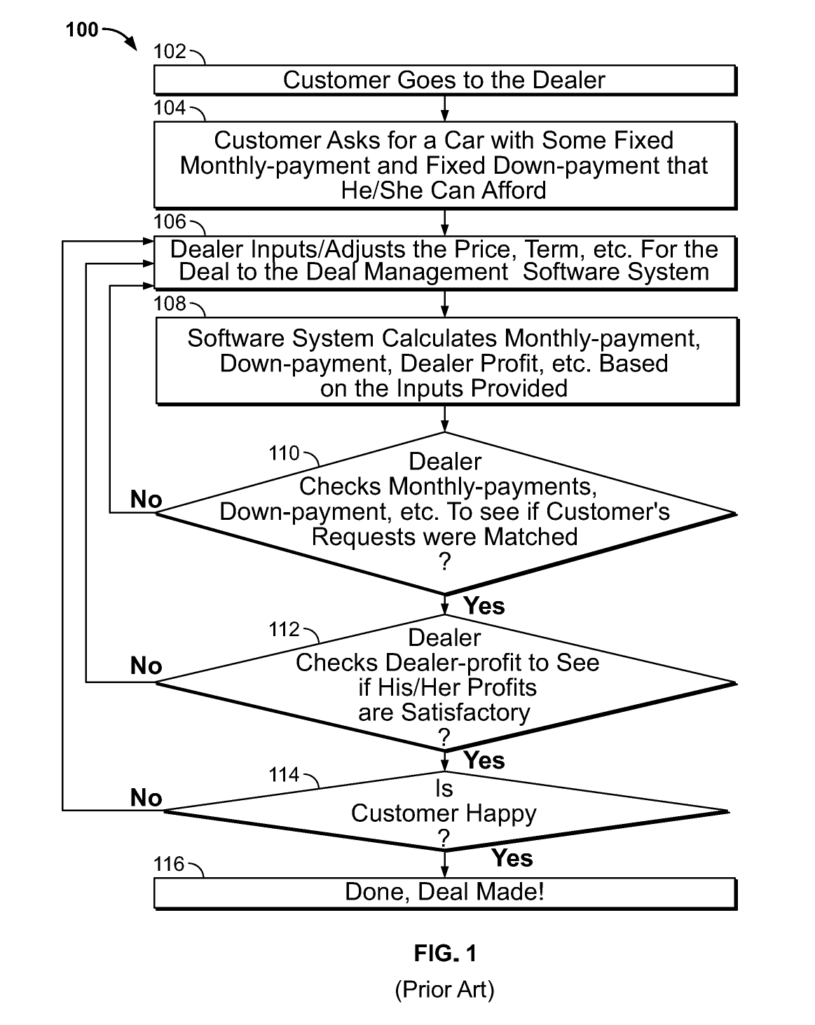

FIG. 2 is a flow diagram depicting an automobile financing procedure according to one embodiment;

FIG. 3 is a block diagram depicting an automobile financing system according to one embodiment;

FIG. 4 is a flow diagram depicting an automobile financing procedure according to one embodiment;

FIG. 5 is a diagram depicting a screen shot of a software program where the software program prompts a user to input a down payment value and monthly gross income value according to one embodiment;

FIG. 6 is a block diagram depicting a computer resource for performing computation based on a customer input, and preloaded inventory, dealer, and lender information according to one embodiment; and

FIG. 7 is a block diagram depicting preloading an individual computer resource according to one embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION OF THE INVENTION

Before the present invention is described in detail, it is to be understood that this invention is not limited to particular variations set forth herein as various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail).

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

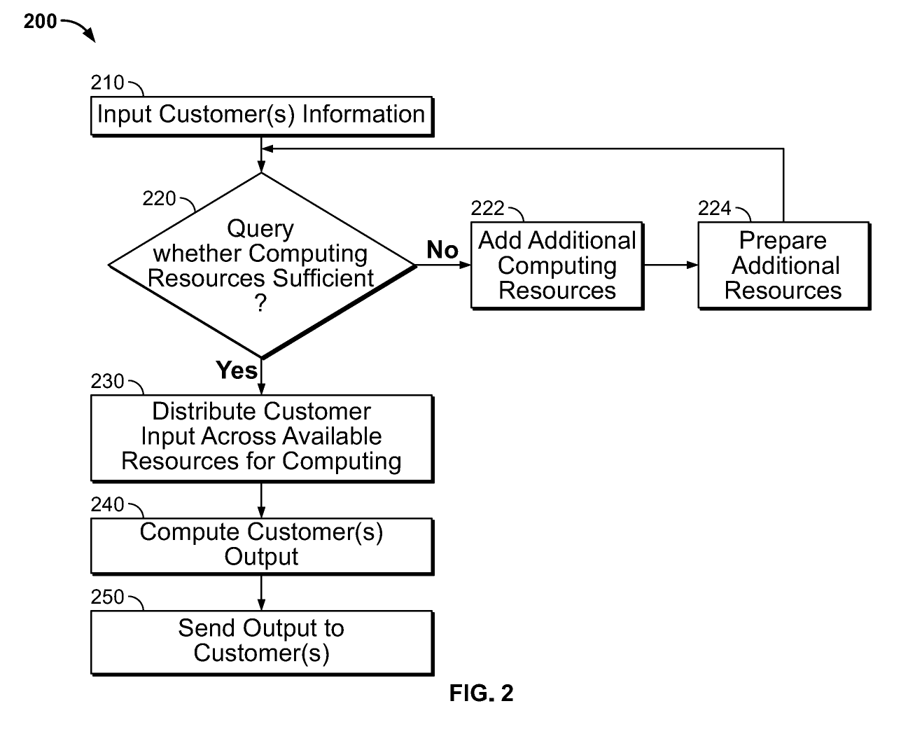

FIG. 2 is a flow diagram depicting an overview of a method 200 for optimizing use of computer resources in performing multiple automobile transactions for multiple customers in accordance with one embodiment of the present invention.

Step 210 states to input customer(s) information. When implemented as a web-based application, discussed further herein, one or more customers may input their information at the same time or near same time. Customer input includes a wide variety of personal and financial information that may affect the terms of the loan. Examples of customer information include, without limitation, name, date of birth, address, loan term, down payment, monthly gross income, length at job, monthly rent payment, and monthly mortgage payment.

Step 220 states to query whether the computing resources are sufficient. As described further herein, in embodiments, a processor computes an operational metric or value based on the existing or then-current computer resources and the anticipated computer power or load needed to carry out the upcoming or anticipated computations.

If the amount of computer resources is deemed sufficient based on the operational metric, the procedure proceeds to step 230 which states to distribute the customer input across the available resources.

In embodiments, the computer resources comprise multiple servers each preloaded with data such that only the customer information is communicated from the customer to the computing resources at the time of the customer request and activity. The preloaded data includes automobile inventory data from one or more dealer lots (e.g., 1 mil or more vehicles), dealer information from one or more dealers (e.g., 1000 or more dealers), and lender constraints and rules for determining loan terms (e.g., 1000 or more lenders).

Examples of automobile inventory information include, without limitation, VIN, make, model, miles, estimated value, condition, color, year, price, body style, trim, MPG, transmission, engine, vehicle equipment, etc.

Examples of dealer information include, without limitation, minimum profit per vehicle, location, tax rate, dealer name, phone number, email address, etc.

Examples of lender constraints and rules include, without limitation, various underwriting criteria, qualification and pricing rules, templates, points, term, APR, minimum credit rating, etc.

Step 240 states to compute the customer(s) output. As described above, in embodiments, the procedure computes the output based on the customer(s) input, and the previously loaded data. Consequently, the amount of data required to be sent to the processor for carrying out the computation step 240 is relatively minimal compared to the data involved in the computation which includes the preloaded inventory, dealer, and lender data and constraints.

Step 250 states to send the output to the customer. As described further herein, data is sent to the customer, for example, to her computer for display.

Examples of output include, without limitation, a listing of one or more automobiles, and loan terms such as monthly payment, loan term, and total price for each automobile, amount financed, state tax, APR, down payment, etc.

In embodiments, as described further herein, a method of ranking and sorting the output is performed based on a customer preference, which may be input before or after the output is sent to the customer for review.

With reference again to step 220, if the amount of computer resources is deemed insufficient based on the operational metric, the procedure proceeds to step 222 which states to add computer resources to the existing or initial computer resources. As described further herein, this step may be performed near instantaneously by adding another storage unit, virtual machine, docket containers, and/or additional server from an available set of servers.

Step 224 states to prepare the added computer resources. The data referenced above (e.g., automobile inventory data, dealer information, and the lender constraints or templates) is pre-added to each computer resource such that during the real-time customer request and computation, only the customer information is required to be sent to each individual computer resource.

Once the added computer resources are created and loaded, the procedure proceeds as described above. Multiple customer output (e.g., 1000 or more customers) is computed (simultaneously if needed) in real time (e.g., 1 second or less) for multiple automobiles (e.g., 1 mil or more), multiple dealers, and multiple lenders.

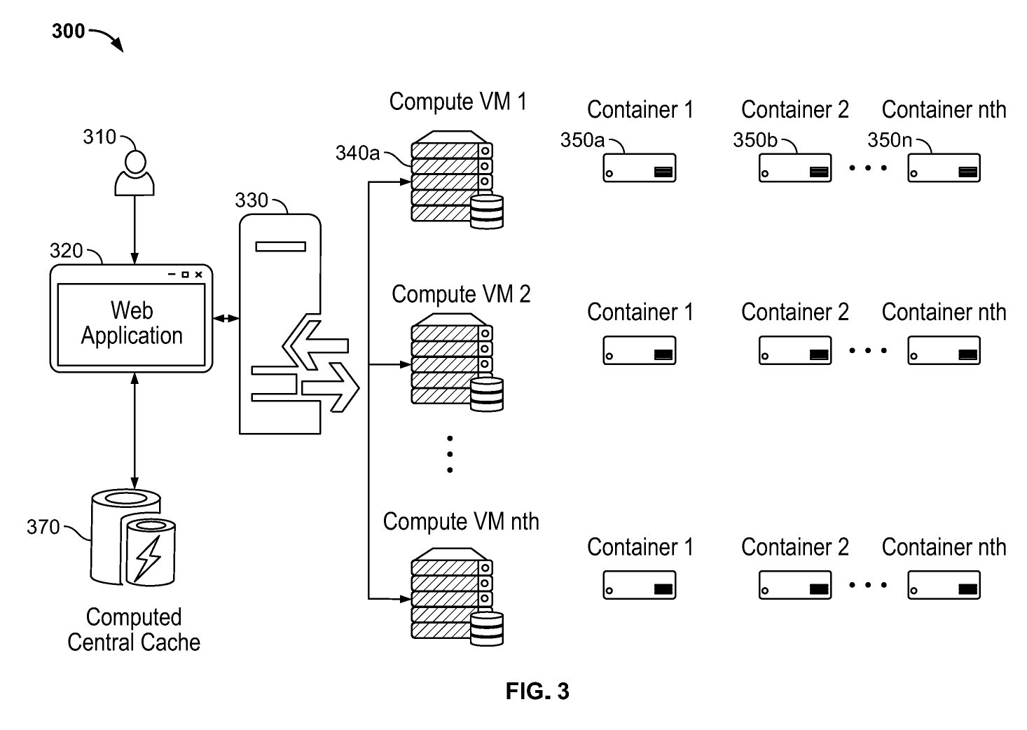

FIG. 3 is a block diagram depicting a system 300 in accordance with one embodiment of the invention.

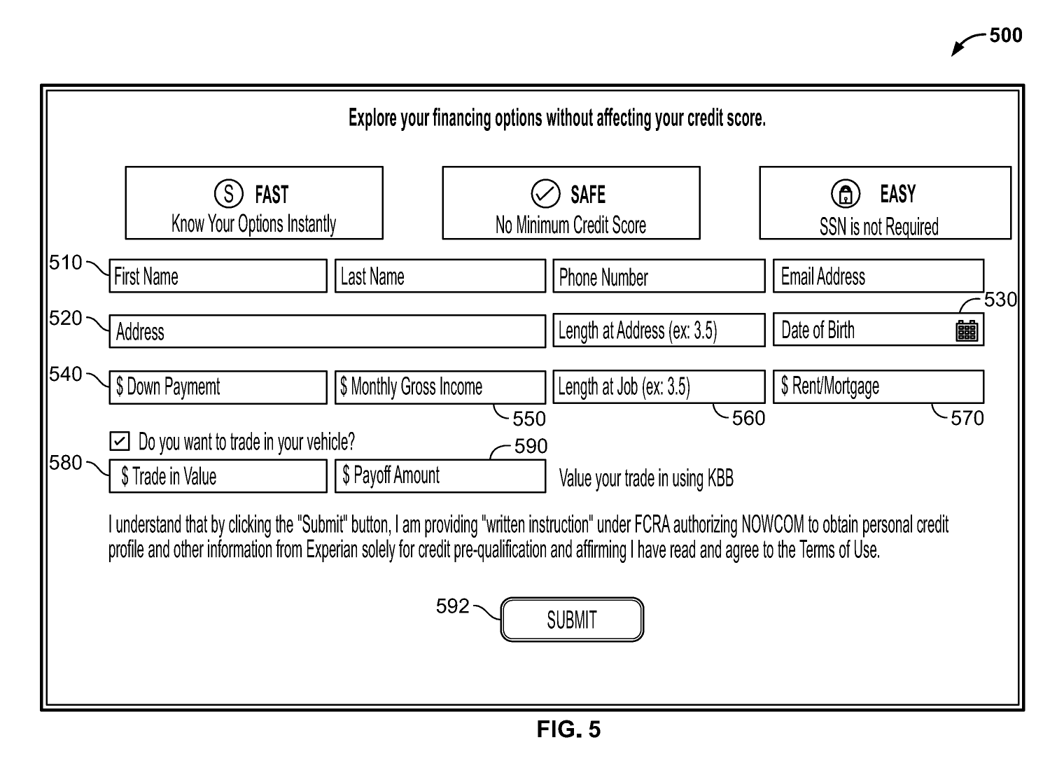

One or more end users 310 are shown making a request on a web application 320. For example, a customer(s) seeking to purchase an automobile inputs her information into the web application. The customer input includes various personal information as described herein. The web application may feature a graphical user interface (GUI) for accepting customer inputs. An example of a GUI is shown in FIG. 5, discussed further herein.

A central processor 330 is shown and operable to receive the customer request. The central processor 330 is operable to identify the current request load on the computer resources, and distribute requests evenly and balanced across the available computer resources.

In embodiments, the computer resources include one or more servers, each comprising a plurality of virtual machines 340a . . . 340n, and each virtual machine comprising a plurality of containers 350a, 350b . . . 350n. An example of a server is the Cisco UCS B200 3M Blade Server manufactured by Cisco Systems Inc. (San Jose, Calif.)

In embodiments, central processor 330 is programmed to identify the current request load from the customers and the number of available containers, and splits up the requests amongst the multiple virtual machines (VMs). The central processor further splits the requests into each VMs own containers.

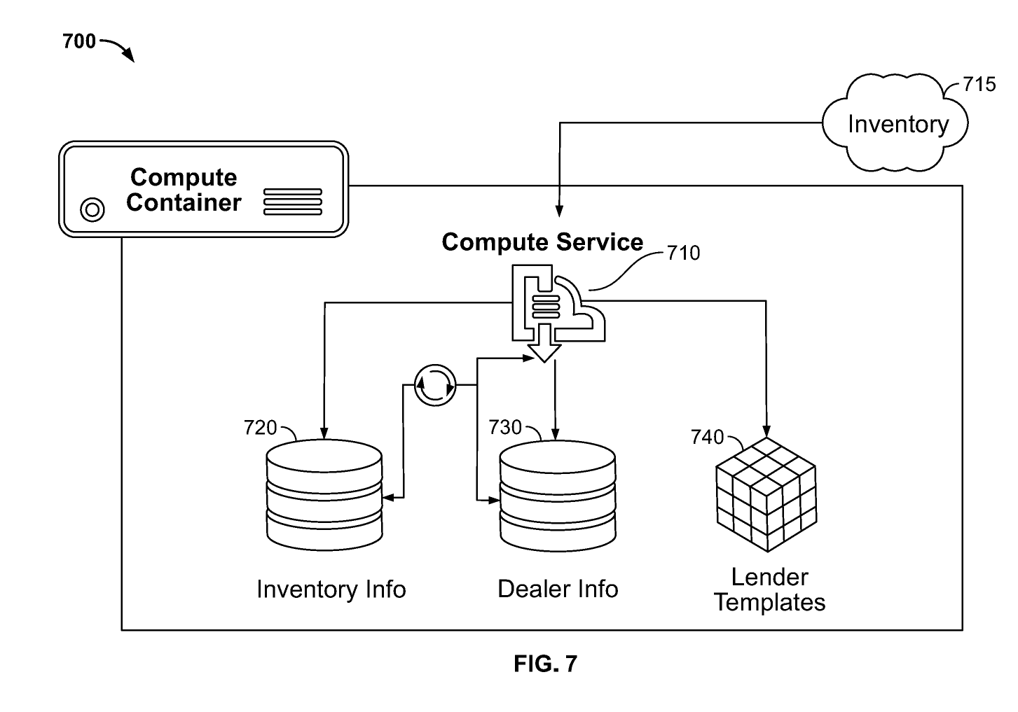

Additionally, if a container is not available for use, one is created and loaded with the data, described further herein with reference to FIG. 7.

In one implementation, a container data technology is built on an open source operating system to scale the number of servers available corresponding to the customer requests instantly and in real time based on the application load. Various open source platforms may be employed to carry out this step (e.g., Linux). In embodiments, scaling of the containerized applications are orchestrated by Kubernetes, an open-source system. See, e.g., https://en.wikipedia.org/wiki/Kubernetes. See also, “What is Kubernetes?”. Kubernetes. Retrieved 2017 Mar. 31.

In embodiments, an operational metric is determined to rank or categorize the need for a new container or more computer resources. The operational metric can be the number of customer requests per second (namely, “RPS”) per container. The central processor 330 can be programmed to monitor the RPS per container and if the RPS per container exceeds a threshold value (e.g., RPS is greater than 1000, 2000, or in some examples 3000) per container, the central processor 330 will send a command or instructions to the container scaling engine (e.g., Kubernetes) to create additional containers and allocate the requests in a predetermined manner (e.g., evenly balanced) to the existing and added containers.

Utilizing the present invention, an unlimited amount of container scaling is obtained in a server farm that can act as an on-premises cloud computing farm, with more virtual machines being created instantly as needed with access to all of the data that is needed.

Although the invention has been described above using servers, virtual machines (VMs), and containers, the invention is not so limited. The type of computer resources may vary widely. Computer resources to be added or made available can include alternative types of storage units and apparatuses comprising a processor and storage capability whether virtual or real, and whether each component or function is shared or dedicated, and regardless of size or physical location.

It should also be noted that the aggregator engine for computing the operational metric and the container scaling engine may share computer resources and reside on one computing device. Or alternatively, the aggregator and computer scaling engine may reside on different computing devices. The invention is only intended to be limited as recited in the appended claims.

In embodiments, one or more components of the individual storage units are shared with other storage units. For example, in embodiments, an operating system and processor may be shared between a group of storage units or containers.

FIG. 3 also shows a central cache 370 in communication with central processor 330 and customers 310 via web application 320. After the central processor reports the calculations have been performed, the computed output is delivered to the central cache 370 and the web application 320 receives all information from that cache 370. Sorting, filtering, and searching through the computed records can be all handled instantly by the central cache 370 so as not to burden the other computer resources such as the servers, VMS, and containers with additional computations.

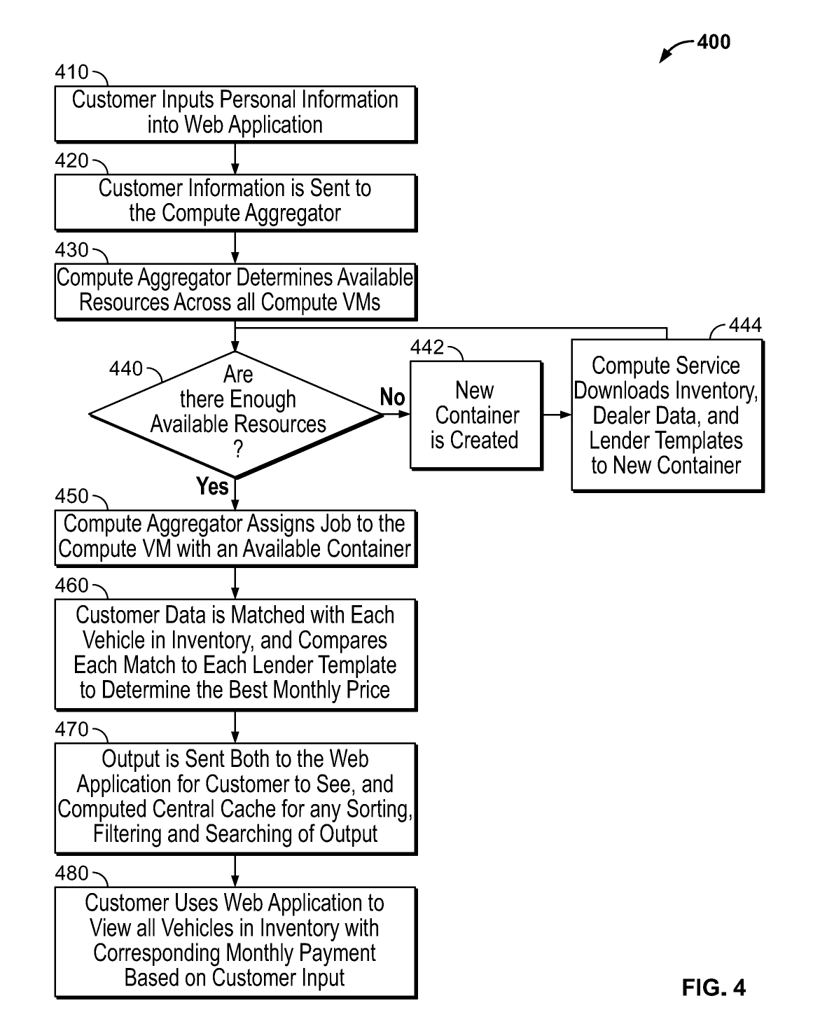

FIG. 4 is another flow diagram depicting an automobile financing procedure 400 according to one embodiment.

Step 410 states customer inputs personal information into the web application. In an implementation, a remote server is programed to interface with the customer via the web. Customer may access the application via various devices including for example computer, tablet, or smart phone.

Step 420 states customer information is sent to the compute aggregator which, in embodiments, is a central processor programmed to carry out a number of computations and send and receive commands, described further herein.

Step 430 states the compute aggregator determines available resources. In embodiments, one or more servers hosts one or more virtual machines, each VM comprising a plurality of containers.

Step 440 states to query whether the available resources are sufficient. This step can be performed as described above in connection with step 220 of FIG. 2, and the central computer processor 330 of FIG. 3.

If the available resources are sufficient, the procedure continues to step 450 which states to assign the job (namely, the customer request) to the VM with an available container.

Step 460 states to match customer input with each vehicle in the inventory, and to compare each match to each lender template to determine predefined output such as, for example, the best or lowest monthly price.

Inventory may vary widely and in embodiments comprises the vehicles from one or more dealers, preferably over 100 dealers. Data may include car make, miles, value estimate based on blue book, location, year, etc.

Lender templates may vary widely and in embodiments comprises templates from one or more lenders, and preferably over 100. The templates may include rules and constraints relating to the APR, minimum credit score, acceptable monthly payment, down payment requirements, etc.

Step 470 states to send the output to the customer and to the central cache for any sorting, filtering, and searching of the output.

Step 480 states for customer to use the web application to view all vehicles in the inventory with corresponding monthly payment based on the customer input.

With reference again to step 440, if the amount of computer resources is deemed insufficient based on the operation metric, the procedure proceeds to step 442 which states to create a new container. As described further herein, this step may be performed near instantaneously by adding another virtual machine, docket container, and or additional server from an available set of servers.

Step 444 states to download inventory, dealer data, and lender templates to the new container. With reference to FIG. 7, when a new container 700 is needed, an application 710 deployed in each container will download the inventory and dealer information 715 into its memory 720, 730 and lender constraints 740 during start up. Additionally, a scheduled job runs in the background (or periodically) and keeps the data from the inventory source 715 and its local data 720, 730 up to date.

Once the added computer resources are created and loaded, the procedure proceeds as described above. Multiple customer output (e.g., 1000 or more customers) is matched (simultaneously if needed) in real time (e.g., 1 second or less) with multiple automobiles (e.g., 1 mil or more), and determines a lowest monthly payment in view of the multiple lenders rules.

FIG. 5 is a diagram depicting a screen shot 500 of a software program where the software program prompts a user to input various personal information including name 510, address 520, date of birth 530, a down payment value 540, monthly gross income 550, length at job 560, rent/mortgage 570, trade in value 580, payoff 590, and a submit tab 592. It is to be understood a graphical user interface may vary widely and the GUI depicted in FIG. 5 is merely one embodiment of the invention.

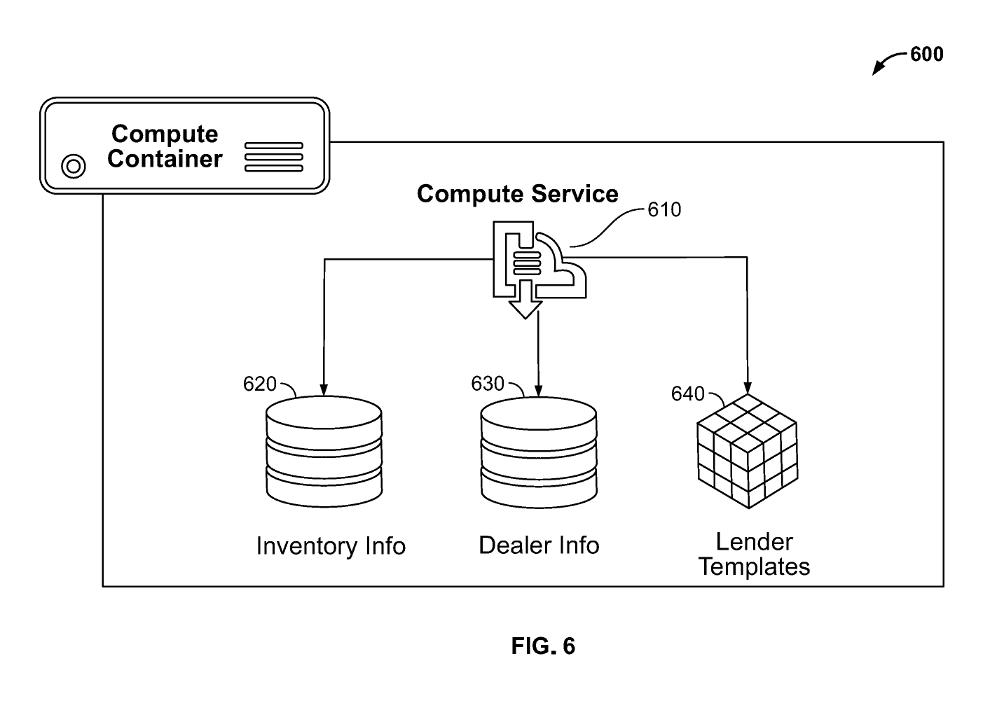

FIG. 6 is a block diagram depicting an individual computer resource 600 according to one embodiment. Particularly, each of the compute containers 600 is preloaded with the required data (vehicles, dealer information, lender logic) in its storages 620, 630, and 640. When the computations are performed by a container's programmed processor 610, the data is all available locally instead of being only accessible from a central database (not shown). Maintaining an updated set of data at the local level, dramatically reduces the customer request and response times. When a request is received from the customer, the container's programmed processor 610 of the container 600 will access the local data 620, 630, 640 and perform the computations for the financial information instantly.

The invention has been discussed in terms of certain embodiments. One of skill in the art, however, will recognize that various modifications may be made without departing from the scope of the invention. For example, numerous variations, changes, and substitutions will now occur to those skilled in the art without departing from the invention. Moreover, while certain features may be shown or discussed in relation to a particular embodiment, such individual features may be used on the various other embodiments of the invention.

For example, in alternative embodiments, the optimization method and system is not limited to automobiles. The methods and system may be utilized to determine customer output for other product types and the steps can be applied in any feasible logical order except where components or steps would exclude one another. Indeed, the invention contemplates optimization computing resources to match customer requests with a wide range of products.

1. A method for optimizing use of computer resources in performing multiple automobile transactions for at least one customer, the computer resources comprising a first plurality of containers, the method comprising:
loading each container of the first plurality of containers with inventory data and lender constraints;
receiving input from the at least one customer;
computing an operational metric for adjusting the number of containers from the first plurality of containers to an optimized number of containers comprising at least one available container;
adjusting the number of containers from the first plurality to the optimized number of containers based on the operational metric;
wherein each container added to the first plurality is automatically loaded with the inventory data and lender constraints;
assigning the input to the at least one available container; and
computing an output for the customer based on the input, inventory data and lender constraints
wherein the inventory data includes automobile data from multiple automobiles, and the lender constraints include lender constraints from at least one lender.

2. The method of claim 1 wherein the output includes identifying multiple automobiles.

3. The method of claim 2 wherein the output includes details associated with each automobile including least one of the following: VIN, monthly payment, and APR.

4. The method of claim 3 further comprising ranking the output based on a customer preference input.

5. The method of claim 1 further comprising eliminating unused containers based on the operational metric.

6. The method of claim 1 further comprising adding the output from each customer to a central cache.

7. The method of claim 1 wherein the loading step is performed by a container processor programmed to load the container periodically.

8. The method of claim 1 further comprising loading dealer data into each container and wherein the dealer data includes data from multiple dealers.

9. The method of claim 1 wherein the computation step computes automobile data comprising at least 1,000,000 automobiles.

10. The method of claim 1 wherein the customer input comprises at least one component selected from the following: loan term, down payment, monthly gross, length at job, monthly rent payment, monthly mortgage payment, name, address, and date of birth.

11. The method of claim 1 further comprising displaying the output to each customer.

12. The method of claim 1 wherein the automobile inventory data includes number of miles per automobile, and car value estimate.

13. The method of claim 1 wherein the dealer data includes a minimum profit.

14. The method of claim 1 wherein the lender constraints include at least one of the following: APR, term, points, minimum credit score estimate.

15. The method of claim 1 wherein the operational metric is at least one selected from the following including: estimated computation time, estimated power usage, estimated CPU processing usage, and estimated memory to be used.

16. The method of claim 1 wherein adjusting the number of containers comprises adding one or more virtual machines, on which the containers operate.

17. The method of claim 16 wherein adjusting the number of containers comprises adding one or more servers on which the virtual machines operate.

18. The method of claim 1 wherein distributing the inputs is performed by distributing the inputs evenly across the optimized number of containers.

19. The method of claim 10 wherein the step of receiving input from at least one customer comprises receiving input from multiple customers simultaneously.

20. A method for optimizing use of computer resources in performing multiple automobile transactions for at least one customer comprising:
preloading a first plurality of storage units with inventory data and lender constraints;
receiving input from at least one customer;
computing whether to adjust the number of storage units to an optimized number of storage units comprising at least one available storage unit;
adjusting the number of storage units to the optimized number of storage units based on the computing step;
wherein each storage unit added to the first plurality is automatically loaded with the inventory data and lender constraints;
assigning the input to the at least one available storage unit; and
computing an output for the customer based on the input, inventory data and lender constraints; and
wherein the inventory data includes product data from multiple products, and the lender constraints include lender constraints from at least one lender.

21. A system for optimizing use of computer resources in performing multiple automobile transactions for at least one customer, the system comprising:
an initial plurality of storage units, and each storage unit previously loaded with inventory data, and lender constraints, and wherein each storage unit is operable to compute a customer output based on the inventory data and lender constraints previously loaded on said storage unit;
a central processor operable to:
receive at least one input from the at least one customer;
compute an operational metric for adjusting the number of storage units to an optimized number of storage units comprising at least one available storage unit; and
send a command to at least one computing resource to adjust the number of storage units based on the computed operational metric; and
wherein the inventory data includes automobile data from multiple automobiles, and the lender constraints include lender constraints from at least one lender.

22. The system of claim 21 further comprising at least one server, and wherein the storage units are hosted on the at least one server.

23. The system of claim 22 further comprising at least one virtual machine hosted on the at least one server, and wherein the storage units are hosted on the virtual machines.

24. The system of claim 23 wherein storage units are containers hosted on the at least one virtual machines.

25. The system of claim 21 further comprising a central cache for storing output for each active customer.

26. The system of claim 21 wherein each storage unit is operable to update inventory data and lender constraints.

27. The system of claim 26 further comprising an automobile inventory database from which each storage unit is updated.

28. The system of claim 21 further comprising a display for showing the output to the customer.
